(19) United States
(12) Patent Application Publication
(10) Pub. No.: US 2013/0282623 A1
(43) Pub. Date: Oct. 24, 2013

(54) Tax Efficient Multi-Manager Equity Separately Managed Account

(71) Applicants: James Stuart Cracraft, Wellesley, MA (US); Martin H. Shore, Brookline, MA (US); Jonathan Farrington Weed, Stoughton, MA (US); Philip Kilborn Thayer, Belmont, MA (US)

(72) Inventors: James Stuart Cracraft, Wellesley, MA (US); Martin H. Shore, Brookline, MA (US); Jonathan Farrington Weed, Stoughton, MA (US); Philip Kilborn Thayer, Belmont, MA (US)

(21) Appl. No.: 13/451,891

(22) Filed: Apr. 20, 2012

(51) Int. Cl. G06Q 40/06

(52) U.S. Cl. 705/36 T; 705/36 R

(57) ABSTRACT

A plurality of model portfolios is received. Each model portfolio is from a respective manager and includes a listing of securities and a respective weight for each security. The plurality of model portfolios is blended to form a blended manager model including a blended listing of securities and a respective blended weight for each security. A separately managed account is constructed by purchasing or trading securities to track at least one characteristic of the blended manager model.

### FIELD OF THE INVENTION

The invention relates generally to methods and systems, including computer program products, for constructing personalized separately managed accounts based on blending multiple model portfolios.

### BACKGROUND

Managers of Unified Managed Accounts (UMAs) obtain equity model portfolios from third party investment managers including a list of stocks and their weights. Whenever the model changes, generally each client account is traded to replicate the changes in the model. The model portfolios are called Separately Managed Account (SMA) models, and it is not uncommon for a UMA to have a significant number of SMAs.

Large warehouse firms have built substantial businesses with hundreds of thousands of client accounts using this technique. There are, however, a number of flaws inherent in this approach.

First, by replicating a model portfolio, the SMA holdings effectively become public. Some top investment firms do not want their holdings to be exposed to avoid the risk of free riding or impacting liquidity. For this reason, institutional-quality investment managers have shied away from offering SMA models and have instead operated under the protections of the 40-Act structure where holdings need not be disclosed immediately. Without access to these top SMA managers, UMA Managers may be giving sub-par performance to their clients.

Second, in many UMA programs, a single SMA is used to gain exposure to an asset class such as US Large Growth stocks. It is not uncommon for these SMAs to hold a relatively small number of stocks, frequently in the range of 40-60. Such concentrated SMAs may expose clients to unnecessarily high levels of company-specific risk. As a result, client portfolio performance can suffer as compared with portfolios of diversified mutual funds which can diversify the company-specific risk with a larger number of holdings.

Third, UMAs and SMAs are often sold with the prospect of tax efficiency since each client holds the underlying stocks individually. However, to be tax efficient, the holding period must be considered to avoid paying short-term capital gain taxes. The SMA model manager has no knowledge of the holding period for each tax lot in each client account. A position that is long-term for one client may be short-term for another. Thus, the SMA model itself is tax inefficient, and therefore, any UMA which replicates the model will be tax inefficient as well. Various academic and industry studies have shown that clients can lose a substantial amount of their return to taxes if not properly managed.

### SUMMARY OF THE INVENTION

The invention, in various embodiments, features a SMA portfolio construction system that addresses flaws inherent in the industry-standard approach. The system can deliver superior risk-adjusted after-tax returns for clients. The technique blends model portfolios (e.g., SMA models) from multiple managers into a blended manager model portfolio. Individual client portfolios are constructed to conform to the target SMA. The individual client portfolios can be personalized based on an account holder's existing security holdings, risk characteristics, transaction cost impact, tax cost impact, or tax situation. The portfolio construction process seeks to closely track the pre-tax performance of the model portfolios, but offer tax efficiency, resulting in higher after-tax portfolio returns.

The blending process can ensure that individual SMA Model holdings are hidden from the public, thereby overcoming a key objection of top investment managers. An account holder or third party can not determine which stock—and in which weight—a particular manager is holding. The manager and his holding can remain anonymous. Gaining access to top investment managers enables clients to receive better investment thinking and pre-tax return potential.

Because multiple manager models are blended, different investment philosophies and skill sets can be blended, which can dampen volatility and improve risk-adjusted returns. For example, a specialized quality-growth manager, a specialized aggressive-growth manager, and a manager that specializes in growth-at-reasonable-price (GARP) can be blended, resulting in greater diversification from uncorrelated managers. Furthermore, managers can be weighted differently depending on, e.g., market conditions, asset class returns, and manager style indicators. For example, if it is believed the economy is recovering from a recession, the aggressive-growth manager can be overweight since this is a period where their style is likely to be in favor. Thus, a tactical bet is another source of potential excess return.

Tax implications can be considered for every buy and sell decision. This balances risk, return, and taxes simultaneously with the goal of maximizing after-tax returns. Specifically, the holding period of each tax lot is considered, and each account holder's individual tax situation is used to determine whether to sell, trim, or hold a position that is no longer in the blended manager model. The spread between short-term and long-term capital gains rates, combined with the time remaining until the position goes long-term is used to calculate the return impact of holding vs. selling. Selling positions that have fallen below their acquisition price, or cost basis, is another way of adding value for clients on an after-tax basis since clients can often deduct these losses on their tax returns or use them to offset gains.

Intra-UMA trading can further improve after-tax returns. UMAs often have SMA's that overlap. For example, a stock can be held—or allowed to be held—in both a US Large Growth SMA as well as a US Large Core SMA. By carefully considering the interaction between SMAs, transaction costs and the impact of taxes can be reduced. For example, if it is determined that stock ABC should be sold out of the US Large Growth SMA, but the stock has been held for less than a year and is at a substantial gain, rather than selling it, the stock can be transferred and incorporated into a US Large Core SMA. Another SMA may be able to work around the position, perhaps selling a similar security at a lower cost. This type of intra-account trading is extremely complex, but benefits the client in the form of lower costs and therefore improved performance.

A side effect of blending multiple managers is an increase in the number of holdings in an account holder's personalized SMA. Even with some overlap between managers, the approach can result in the target blended model portfolio having as many as 150 stocks, which may be less desirable for certain clients. A technique can be used to pare the number of positions during the tax-aware portfolio construction process and optimize the trade-off between risk, return, taxes, and number of holdings. The technique is a combination of portfolio construction and manager selection. Carefully selecting managers who have specific characteristics to the models is part of the paring process. For example, managers who have a very large number of small positions, which collectively represent a large active weight, may not be good candidates for the investment process.

In one aspect, there is a method of forming a separately managed account. The method includes receiving, by a computing device, a plurality of model portfolios. Each model portfolio is from a respective manager and includes a listing of securities and a respective weight for each security. The method also includes blending, by the computing device, the plurality of model portfolios to form a blended manager model including a blended listing of securities and a respective blended weight for each security, and constructing, by the computing device, the separately managed account by purchasing or trading securities to track at least one characteristic of the blended manager model.

In another aspect, there is a computer program product, tangibly embodied in a computer-readable storage medium, the computer program product including instructions being operable to cause a data processing apparatus to: receive a plurality of model portfolios, each model portfolio from a respective manager and comprising a listing of securities and a respective weight for each security; blend the plurality of model portfolios to form a blended manager model including a blended listing of securities and a respective blended weight for each security; and construct the separately managed account by purchasing or trading securities to track at least one characteristic of the blended manager model.

In still another aspect, there is a system comprising a computing processor configured to: receive a plurality of model portfolios, each model portfolio from a respective manager and comprising a listing of securities and a respective weight for each security; blend the plurality of model portfolios to form a blended manager model including a blended listing of securities and a respective blended weight for each security; and construct the separately managed account by purchasing or trading securities to track at least one characteristic of the blended manager model.

In yet another aspect, there is an apparatus for forming a separately managed account. The apparatus includes means for receiving a plurality of model portfolios. Each model is portfolio from a respective manager and includes a listing of securities and a respective weight for each security. The apparatus further includes means for blending the plurality of model portfolios to form a blended manager model including a blended listing of securities and a respective blended weight for each security, and means for constructing the separately managed account by purchasing or trading securities to track at least one characteristic of the blended manager model.

In other examples, any of the aspects above, or any apparatus, system or device, or method, process or technique, described herein, can include one or more of the following features.

The separately managed account can be personalized for an account holder based on one or more of the holder's existing security holdings, risk characteristics, transaction cost impact, tax cost impact, or tax situation.

In various embodiments, it is determined if any of the respective managers is holding an unacceptable security for the blended manager model. If so, the unacceptable security can be removed from the respective model portfolio or replaced with an acceptable replacement security in the respective model portfolio. The securities in the respective model portfolio can be reweighed prior to blending to account for removal or replacement of the unacceptable security.

In some embodiments, it is determined if any security in one or more of the plurality of model portfolios should be adjusted for a corporate action (e.g., a split, a spin-off or an acquisition). If so, the securities in the respective model portfolio can be reweighed to account for the corporate action.

In various embodiments, it is determined if any of the respective managers is holding cash in their respective model portfolio. If so, the cash can be removed from the respective model portfolio, and the securities can be reweighed in the respective model portfolio in the absence of the cash.

In certain embodiments, a manager weight is received for each of the plurality of model portfolios, and the respective blended weight of each security in the blended listing of securities is adjusted to account for the manager weight.

In certain embodiments, information about market conditions is received, and the respective blended weights of each security in the blended listing of securities is adjusted to account for the market conditions.

In some embodiments, blending the plurality of model portfolios to form the blended manager model includes at least two of (i) reweighting remaining securities in the respective model portfolio prior to blending to account for removal of the unacceptable security, (ii) reweighting the securities in the respective model portfolio prior to blending to account for replacement of the unacceptable security, (iii) reweighting the securities in the respective model portfolio to account for the corporate action, (iv) reweighting the securities in the respective model portfolio in the absence of the cash, (v) adjusting the respective blended weights of each security in the blended listing of securities to account for the manager weight, or (vi) adjusting the respective blended weights of each security in the blended listing of securities to account for the market conditions. Blending can ensure that each respective manager remains anonymous. Each model portfolio can include a single asset class of equities.

In various embodiments, a revised model portfolio from at least one of the respective managers is received. The plurality of model portfolios including the revised model portfolio is reblended to form a revised blended manager model including a revised blended listing of securities and a respective revised blended weight for each security. Securities are bought or sold to form a revised separately managed account. Tax lots for each security in the separately managed account can be tracked to maximize after-tax returns when forming the revised separately managed account.

In some embodiments, the separately managed account is tracked against the blended manager model. An unacceptable deviation from the blended manager model can be identified. Securities are bought or sold to form a revised separately managed account ameliorate the unacceptable deviation.

In various embodiments, a plurality of separately managed accounts is constructed. Each separately managed account is for a different account holder, is based on the blended manager model, and is personalized for the respective account holder based on one or more of the holder's existing security holdings, risk characteristics, transaction cost impact, tax cost impact, or tax situation. In certain embodiments, each separately managed account is for a single account holder and is based on securities selected from a different asset class.

In some embodiments, an order to buy or sell a security in a first asset class is generated. It is determined that buying or selling a different security in a different asset class would maximize after-tax returns. For each asset class, the plurality of model portfolios is reblended to form a revised blended manager model including a revised blended listing of securities and a respective revised blended weight for each security in the asset class. The revised blended manager model for the first asset class includes the security if a sell order was received or does not include the security if a buy order was received. Securities are bought or sold to form revised separately managed accounts for each asset class.

In various embodiments, a portfolio weight is assigned to each model portfolio based on the respective manager. The portfolio weight of each model portfolio within the blended manager model can be dynamically adjusted to account for the respective manager.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a flow diagram showing a computer implemented process forming a separately managed account.

FIG. 2 is a flow diagram showing a computer implemented process for adjusting for a manager weight in a blended manager model.

FIG. 3 is a flow diagram showing a computer implemented process for accounting for unacceptable securities, corporate actions or cash in portfolio models.

FIG. 4 is a flow diagram showing a computer implemented process for weighting managers in a blended model portfolio.

FIG. 5 is a flow diagram showing a computer implemented process for constructing a separately managed account.

### DETAILED DESCRIPTION

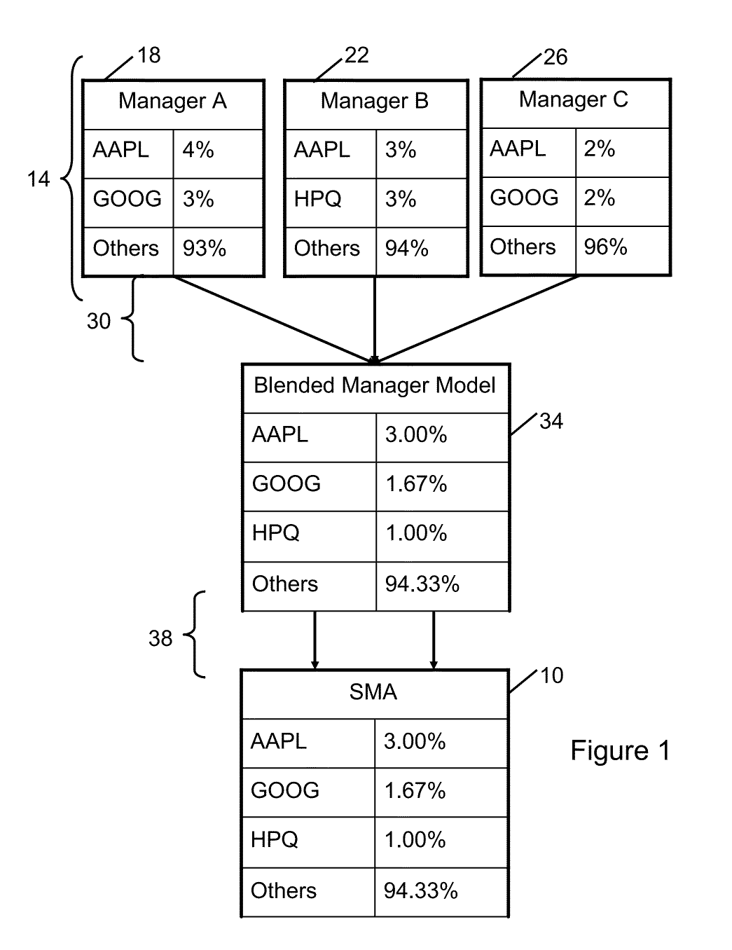

FIG. 1 is a flow diagram showing a computer implemented process for forming a separately managed account 10. A plurality of model portfolios is received (14). Each model portfolio 18, 22 and 26 is from a respective manager and includes a listing of securities and a respective weight for each security. The plurality of model portfolios is blended (30) to form a blended manager model 34 including a blended listing of securities and a respective blended weight for each security. The separately managed account 10 is constructed (38) by purchasing or trading securities to track at least one characteristic of the blended manager model. In various embodiments, the characteristic of the blended manager model can be, for example, one or more of a P/E ratio, a dividend yield, a market capitalization, sector weights, a tracking error, pre-tax return, after-tax return, or the blended listing of securities at the respective blended weights.

In FIG. 1, three model portfolios 18, 22 and 26 are shown, although two, or more than three, can be used. Each includes a manager name (A, B or C), a listing of stocks and a percentage of that stock as it appears in the respective portfolio 18, 22 and 26. The securities are not limited to stocks. The securities can be stocks, bonds, stock ETF's, bond ETF's, mutual funds, cash or other securities typically held by equity managers. Securities are shown weighted by percentage, although other weighting models can be used. Typically, 25 to 100 securities are held by any single manager, although the number of securities is not limited to this range. For illustration purposes, only three stocks are shown.

Model portfolio 18 from Manager A, model portfolio 22 from Manager B, and model portfolio 26 from Manager C are blended to form blended manager model 34, which includes a blended listing of securities and a respective blended weight for each security. The blended weight for each security can be solved for by summing the value of each security in each portfolio, and dividing it by the total value of all securities in the three portfolios, although other processes for determining blended weights can be used.

Once the blended manager model 34 is formed, the separately managed account 10 is constructed. Securities can be purchased to track at least one characteristic of the blended manager model 34. If an account holder already has an existing separately managed account, and the goal is to conform the existing separately managed account to the blended manager model 34, securities can be bought, sold or traded to form the separately managed account 10. Blending of securities can ensure that the model manager remains anonymous.

The separately managed account 10 can be personalized for an account holder based on one or more of the holder's existing security holdings, risk characteristics, transaction cost impact, tax cost impact, or tax situation. Therefore, the separately managed account 10 need not include every security in the blended manager model 34 at the exact percentage of the blended manager model 34. For example, HPQ could be excluded from the separately managed account 10 if for some reason HPQ was deemed to be unacceptable. If a security is excluded, the blended manager model 34 is reweighted prior to constructing the separately managed account 10.

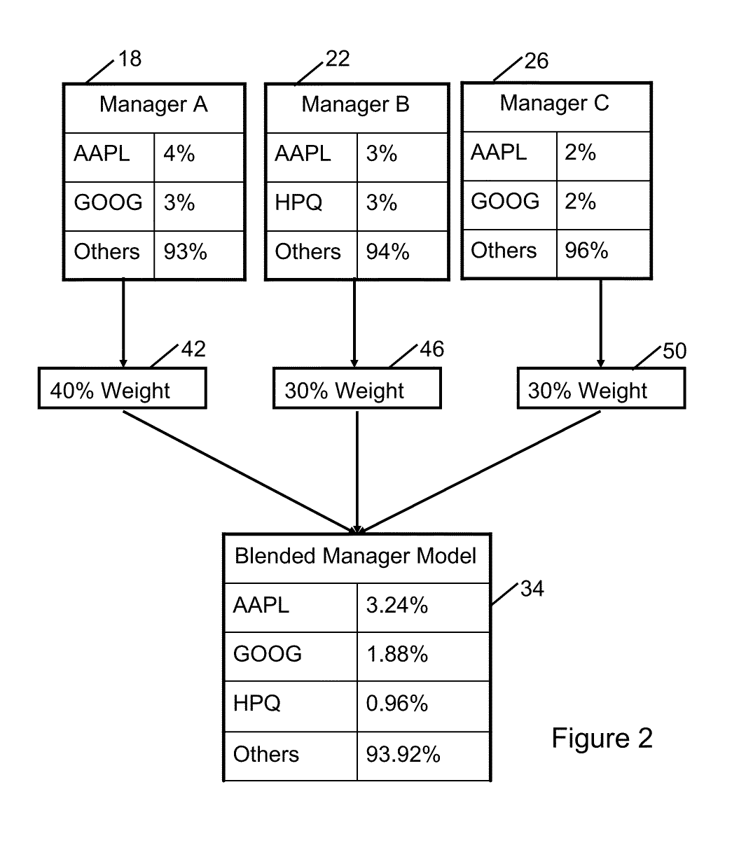

The blended manager model 34 can account for a manager weight. FIG. 2 shows that each model portfolio 18, 22 and 26 includes a respective manager weight 42, 46 and 50. The respective blended weight of each security in the blended manager model 16 is adjusted to account for the manager weight. Information about market conditions can be received, and the respective blended weights of each security in the blended listing of securities can be adjusted to account for the market conditions. For example, if bearish conditions exist and one of the managers is particularly bullish, then the weight for the bullish manager can be lowered.

Prior to blending, or as part of the blending process, each model portfolio 18, 22 and 26 can be screened for securities that can be excluded from the blended model or for securities for which an adjustment can be made to improve inter-comparison of model portfolios.

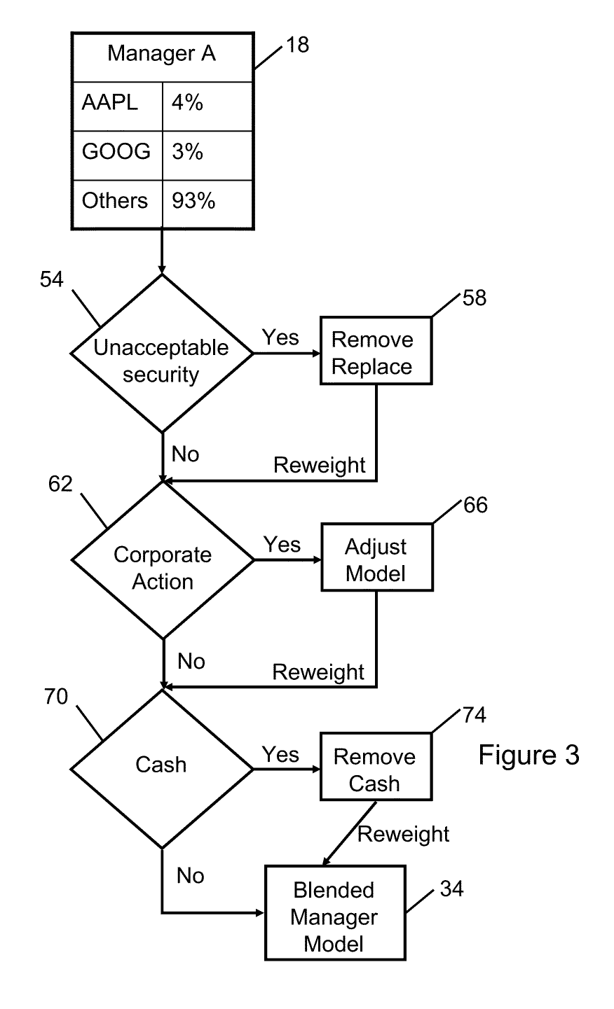

In FIG. 3, model portfolio 18 is screened for an unacceptable security (54). If it is determined that any of the respective managers is holding an unacceptable security for the blended manager model 34, the unacceptable security can be removed from the respective model portfolio or replaced with an acceptable replacement security in the respective model portfolio (58). The securities in the respective model portfolio can be reweighed prior to blending to account for removal or replacement of the unacceptable security.

For example, if a client does not want to hold a particular security or a particular type of securities, the security can be excluded from the blended manager model. The weight for the particular security can be taken by a replacement security (e.g., with a similar style, from the same asset class and/or having a comparable market cap) or distributed among remaining securities. In another example, if a first large cap value stock is held by manager A and a second similar but different large cap value stock is held by manager B, then the second large cap value stock can be excluded from the blended portfolio with its weight made up by the first large cap value stock.

Asset class refers to a securities style. For example, stocks, stock mutual funds and stock ETF's can be categorized by market cap and style (e.g., large-cap growth, large-cap value, large-cap core, mid-cap growth, mid-cap value, mid-cap core, small-cap growth, small-cap value, or small-cap core). Within an asset class such as value, subclasses or tiers exist, such as deep value, relative value or traditional value. Growth can include aggressive growth, quality growth or GARP. Bonds, bond mutual funds and bond ETF's can be categorized by duration (e.g., short, medium and long term) and quality (investment grade, treasury/agency, municipal, investment grade corporate, below investment grade corporate, high-yield, junk, foreign, and/or emerging market).

In FIG. 3, model portfolio 18 is screened for one or more corporate actions (62). If it is determined that any security in one or more of the plurality of model portfolios should be adjusted for a corporate action (e.g., a split, a spin-off or an acquisition), an adjustment can be made (66) and the securities in the respective model portfolio can be reweighed to account for the corporate action. For example, manager A may have purchased a security prior to a split and manager B may have purchased the same security after a split. So that the number of shares and security prices are comparable, manager A's holding can be split adjusted.

In FIG. 3, model portfolio 18 is screened for cash (70). If it is determined that any of the respective managers is holding cash in their respective model portfolio, and the cash is undesirable, the cash can be removed from the respective model portfolio (74). The securities can be reweighed in the respective model portfolio in the absence of the cash. In some embodiments, where a more conservative investment style is desired or where market conditions are particularly bearish, cash may be desired and this step of screening for cash can be excluded. In certain embodiments, an ETF or futures contract can be purchased to equitize the cash.

Screening for manager weight, market conditions, unacceptable securities (54), corporate actions (62), and/or cash (70) can be performed in a single step or in consecutive steps. Screening need not occur in the order shown in FIG. 3. In some embodiments, two or more of these actions can be performed.

Because multiple manager models are blended, different investment philosophies and skill sets can be blended. For example, a specialized quality-growth manager, a specialized aggressive-growth manager, and a manager that specializes in GARP can be blended, resulting in greater diversification from uncorrelated managers. Furthermore, managers can be weighted differently depending on, e.g., market conditions, asset class returns, and manager style indicators. For example, if it is believed the economy is recovering from a recession, the aggressive-growth manager can be overweight since this is a period where their style is likely to be in favor. Thus, a tactical bet is another source of potential excess return.

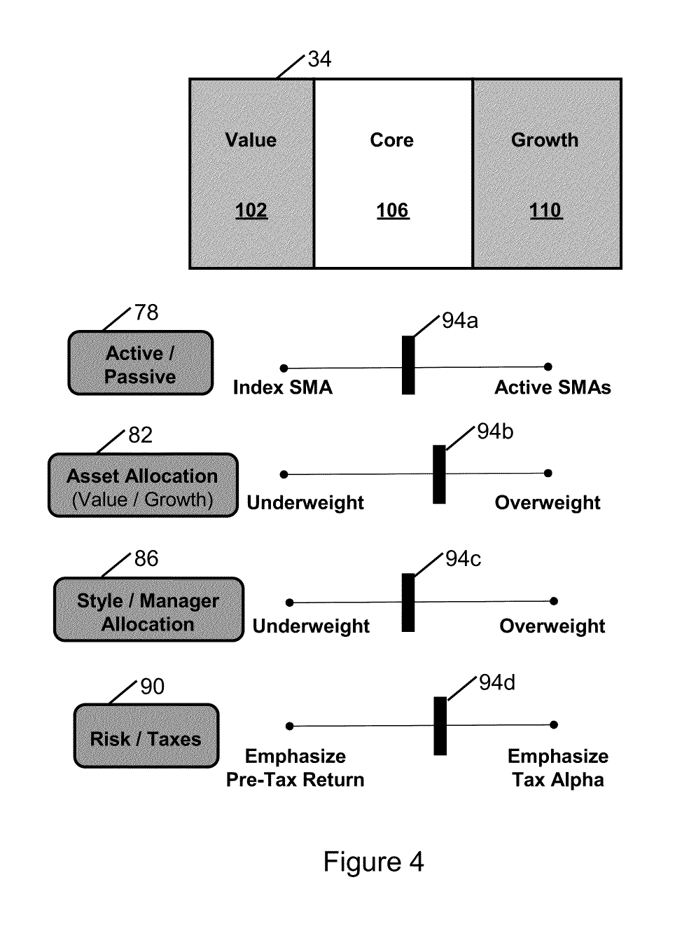

FIG. 4 shows a user interface for a manager weighting model. A portfolio can be adjusted for investment characteristics, such as tracking a benchmark 78 (e.g., active vs. passive), asset allocation 82 (e.g., value vs. growth), manager style 86 (e.g., deep value, relative value, traditional value, aggressive growth, quality growth or GARP), and tax performance 90. Each investment characteristic can include a slider 94x for adjustment.

In FIG. 4, a blended manager model 34 includes three manager models, a value SMA 102, a core SMA 106 and a growth SMA 110. Any of the three manager models can be actively managed or passively managed (e.g., the model can track an index such as the S&P 500). In certain embodiments, the value SMA 102 and the growth SMA 110 are actively managed and the core SMA 106 is passively managed.

The slider 94a for tracking a benchmark 78 can be adjusted to change the overall size of the blended manager model 34. If more passive exposure is desired, the core SMA 106 is made larger, and the value SMA 102 and the growth SMA 110 components are made smaller.

The slider 94b for asset allocation 82 can change the overall size of the value SMA 102 and the growth SMA 110. If growth is believed to outperform value, the weight of the growth SMA 110 is increased and the weight of the value SMA 102 is decreased.

The slider 94c for manager style 86 can increase or decrease one of the manager's exposure based on market conditions. For example, the value SMA 102 can have tiers, such as “Deep Value,” Relative Value” and “Traditional Value.” The weighting of the tiers within the value SMA component of the blended manager model 34 can be fine tuned. Similarly, the growth SMA 110 can include “Aggressive Growth,” “Quality Growth” and “GARP.”

With the industry standard approach, where there is just a single manager, an “all weather” portfolio is selected. No active manager is able to outperform under all market conditions. Therefore, the manager style 86 adjuster provides an advantage because blending three managers with very different styles means there is a greater likelihood that one of the manager's style is in favor at any particular time. Their uncorrelated return streams lower risk (provide greater diversification) while the blended manager model 34 can exploit their stock-picking alpha. A multi-manager SMA has a 50%-100% higher information ratio than a single manager. Both the value SMA 102 and the growth SMA 110 can have separate sliders.

The slider 94d for tax performance 90 can fine tune the relationship between pre-tax performance (e.g., track the blended SMA very tightly) and after-tax performance (e.g., allow tax preference to drive the client's SMA). The blended SMA can have more securities and less risk than the industry standard approach.

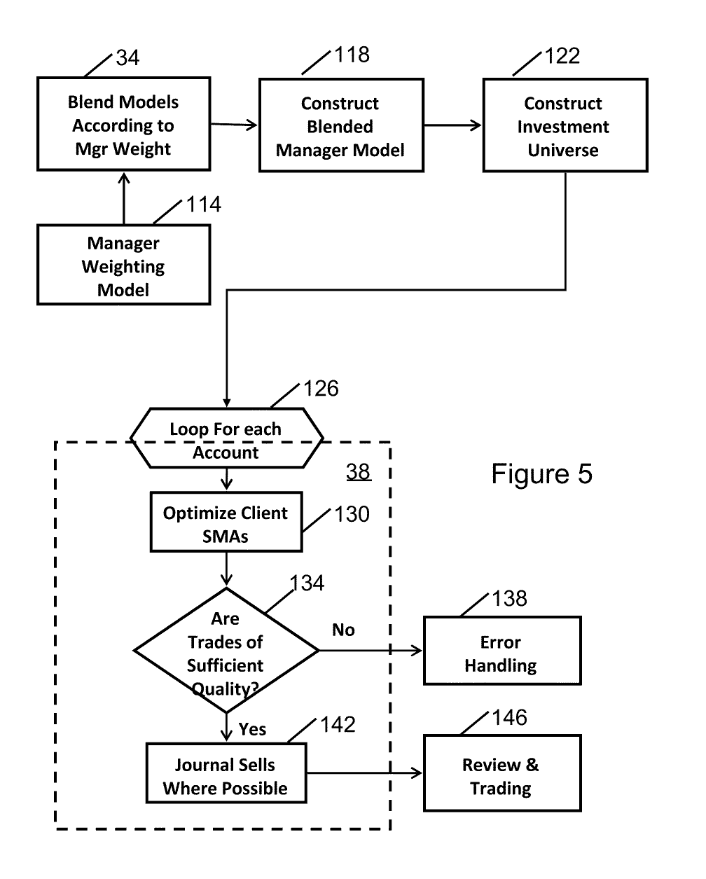

FIG. 5 shows an example of a process 38 for constructing a separately managed account 10. The blended manager model 34 can be processed with a manager weighting model 114 (e.g., the process shown in FIG. 4). Based on the blended manager model 34, a benchmark portfolio 118 can be constructed for comparison. A universe of securities 122 for purchase is constructed.

In FIG. 5, a separately managed account 10 is formed for each account holder (126). For example, a plurality of separately managed accounts can be constructed. Each separately managed account is for a different account holder and is based on the blended manager model. In certain embodiments, each separately managed account is for a single account holder and is based on securities selected from different asset classes.

The separately managed account 10 is optimized for each account holder (130). For example, each account can be personalized for the respective account holder based on one or more of the holder's existing security holdings, risk characteristics, transaction cost impact, tax cost impact, or tax situation.

Each trade can be reviewed to determine its quality (134). If the trade is not acceptable, an error handling procedure can be implemented (138). If the trade is acceptable, the trade can happen in one of two ways. It can be traded in the market or, in some cases, it can be transferred (journaled) to another part of the client's portfolio (142). Journaling is advantageous because it eliminates transaction costs and defers realizing taxes. Trading (146) can be performed to form the separately managed account 10.

In some embodiments, an order to buy or sell a security in a first asset class is generated. It is determined that buying or selling a different security in a different asset class would maximize after-tax returns. For each asset class, the plurality of model portfolios is reblended to form a revised blended manager model including a revised blended listing of securities and a respective revised blended weight for each security in the asset class. The revised blended manager model for the first asset class includes the security if a sell order was received or does not include the security if a buy order was received. Securities are bought or sold to form revised separately managed accounts for each asset class.

In some embodiments, the separately managed account 10 is tracked against a benchmark 118 (e.g., the blended manager model). An unacceptable deviation from the benchmark or blended manager model can be identified. Securities are bought or sold to form a revised separately managed account to ameliorate the unacceptable deviation.

In various embodiments, a revised model portfolio can be received from one or more of the respective managers (14). The process shown in FIG. 1 can be re-run to accommodate the new model(s). Revised models can be received on a daily basis, a weekly basis or on a monthly basis. The plurality of model portfolios including the revised model portfolio is reblended to form a revised blended manager model including a revised blended listing of securities and a respective revised blended weight for each security (30). Securities are bought or sold to form a revised separately managed account (38). Tax lots for each security in the separately managed account can be tracked to maximize after-tax returns when forming the revised separately managed account.

The above-described systems and methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, tablet) with a world wide web browser (e.g., Microsoft® Internet Explorer® available from Microsoft Corporation, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of forming a separately managed account, comprising:
receiving, by a computing device, a plurality of model portfolios, each model portfolio from a respective manager and comprising a listing of securities and a respective weight for each security;
blending, by the computing device, the plurality of model portfolios to form a blended manager model including a blended listing of securities and a respective blended weight for each security; and
constructing, by the computing device, the separately managed account by purchasing or trading securities to track a pre-tax return of the blended manager model.

2. The method of claim 1 further comprising personalizing, by the computing device, the separately managed account for an account holder based on one or more of the holder's existing security holdings, risk characteristics, transaction cost impact, tax cost impact, or tax situation.

3. The method of claim 1 further comprising:
determining, by the computing device, if any of the respective managers is holding an unacceptable security for the blended manager model;
if the respective managers is holding an unacceptable security, removing, by the computing device, the unacceptable security from the respective model portfolio or replacing, by the computing device, the unacceptable security with an acceptable replacement security in the respective model portfolio; and
reweighting, by the computing device, the securities in the respective model portfolio prior to blending to account for removal or replacement of the unacceptable security.

4. The method of claim 1 further comprising:
determining, by the computing device, if any security in one or more of the plurality of model portfolios should be adjusted for a corporate action including a split, a spin-off or an acquisition;
if the respective manager is holding a security subject to the corporate action, reweighting, by the computing device, the securities in the respective model portfolio to account for the corporate action.

5. The method of claim 1 further comprising:
determining, by the computing device, if any of the respective managers is holding cash in their respective model portfolio;
if the respective manager is holding cash, removing, by the computing device, the cash from the respective model portfolio; and
reweighting, by the computing device, the securities in the respective model portfolio in the absence of the cash.

6. The method of claim 1 further comprising:
receiving, by the computing device, a manager weight for each of the plurality of model portfolios; and
adjusting, by the computing device, the respective blended weights of each security in the blended listing of securities to account for the manager weight.

7. The method of claim 1 further comprising:
receiving, by the computing device, information about market conditions;
adjusting, by the computing device, the respective blended weights of each security in the blended listing of securities to account for the market conditions.

8. The method of claim 1 wherein blending the plurality of model portfolios to form the blended manager model comprises at least two of (i) reweighting remaining securities in the respective model portfolio prior to blending to account for removal of the unacceptable security, (ii) reweighting the securities in the respective model portfolio prior to blending to account for replacement of the unacceptable security, (iii) reweighting the securities in the respective model portfolio to account for the corporate action, (iv) reweighting the securities in the respective model portfolio in the absence of the cash, (v) adjusting the respective blended weights of each security in the blended listing of securities to account for the manager weight, or (vi) adjusting the respective blended weights of each security in the blended listing of securities to account for the market conditions.

9. The method of claim 1 wherein blending ensures each respective manager remains anonymous.

10. The method of claim 1 wherein each model portfolio comprises a single asset class of equities.

11. The method of claim 1 further comprising:
receiving, by the computing device, a revised model portfolio from at least one of the respective managers;
reblending, by the computing device, the plurality of model portfolios including the revised model portfolio to form a revised blended manager model including a revised blended listing of securities and a respective revised blended weight for each security; and
buying or selling, by the computing device, securities to form a revised separately managed account.

12. The method of claim 11 further comprising tracking, by the computing device, tax lots for each security in the separately managed account to maximize after-tax returns when forming the revised separately managed account.

13. The method of claim 1 further comprising:
tracking, by the computing device, the separately managed account against the blended manager model;
identify, by the computing device, an unacceptable deviation from the blended manager model;
buying or selling, by the computing device, securities to form a revised separately managed account to ameliorate the unacceptable deviation.

14. The method of claim 1 further comprising constructing, by the computing device, a plurality of separately managed accounts, each separately managed account being for a different account holder, being based on the blended manager model, and being personalized for the respective account holder based on one or more of the holder's existing security holdings, risk characteristics, transaction cost impact, tax cost impact, or tax situation.

15. The method of claim 1 further comprising constructing, by the computing device, a plurality of separately managed accounts, each separately managed account being for a single account holder and being based on securities selected from a different asset class.

16. The method of claim 1 further comprising:
generating, by the computing device, an order to buy or sell a security in a first asset class;
determining, by the computing device, that buying or selling a different security in a different asset class would maximize after-tax returns;
for each asset class, reblending, by the computing device, the plurality of model portfolios to form a revised blended manager model including a revised blended listing of securities and a respective revised blended weight for each security in the asset class, wherein the revised blended manager model for the first asset class includes the security if a sell order was received or does not include the security if a buy order was received; and
buying or selling, by the computing device, securities to form revised separately managed accounts for each asset class.

17. The method of claim 1 further comprising:
assigning, by the computing device, a portfolio weight to each model portfolio based on the respective manager; and
dynamically adjusting, by the computing device, the portfolio weight of each model portfolio within the blended manager model.

18. A computer program product, tangibly embodied in a computer-readable storage medium, the computer program product including instructions being operable to cause a data processing apparatus to:
receive a plurality of model portfolios, each model portfolio from a respective manager and comprising a listing of securities and a respective weight for each security;
blend the plurality of model portfolios to form a blended manager model including a blended listing of securities and a respective blended weight for each security; and
construct the separately managed account by purchasing or trading securities to track at least one characteristic of the blended manager model.

19. A system comprising:
a computing processor configured to:
receive a plurality of model portfolios, each model portfolio from a respective manager and comprising a listing of securities and a respective weight for each security;
blend the plurality of model portfolios to form a blended manager model including a blended listing of securities and a respective blended weight for each security; and
construct the separately managed account by purchasing or trading securities to track at least one characteristic of the blended manager model.
